(19) United States
(12) Patent Application Publication
(10) Pub. No.: US 2008/0148592 A1
(43) Pub. Date: Jun. 26, 2008

(54) DRYER WITH SAFETY FUNCTION

(76) Inventors: Yang-hwan KIM, Busan (KR); Kyung-hun Kim, Changwon-shi (KR); Ja-in Koo, Changwon-shi (KR); Ju-hyun Kim, Jinhae-shi (KR); Sun-cheol Bae, Masan-shi (KR); Ju-young Min, Changwon-shi (KR); Jin-seok Hu, Masan-shi (KR)

Correspondence Address: KED & ASSOCIATES, LLP, P.O. Box 221200, Chantilly, VA, 20153-1200, US

(21) Appl. No.: 11/937,684

(22) Filed: Nov. 9, 2007

(30) Foreign Application Priority Data
Dec. 26, 2006 (KR) 10-2006-0133890

(51) Int. Cl. F26B 19/00; G06F 9/00

(52) U.S. Cl. 34/89; 700/205

(57) ABSTRACT

The present invention discloses a dryer with safety function which can interrupt a drying operation of the dryer in clogging of an exhaust duct. The dry with safety function includes a judgment means for judging clogging of the exhaust duct, and a display means interworking with the judgment means, for displaying the clogging state of the exhaust duct in clogging of the exhaust duct. The user can be rapidly informed of the clogging state of the exhaust duct.

### TECHNICAL FIELD

The present invention relates to a dryer, and more particularly, to a dryer with safety function which can interrupt a drying operation of the dryer when an exhaust duct of the dryer is clogged.

### BACKGROUND ART

In general, a washing machine with a drying function includes a main body formed in a predetermined shape, a drum installed in the main body, a tub for surrounding the drum and collecting the wash water, a driving motor for rotating the drum, a detergent container for supplying a detergent, a water supply tube connected to the detergent container, for supplying the wash water only or the wash water mixed with the detergent of the detergent container, a drain tube for externally discharging the wash water used in washing, and a pump and a drain hose connected to the end of the drain tube, for forcibly discharging the wash water.

In the washing machine with the drying function, after the laundry and the wash water are put into the drum, the drum is rotated so that the laundry can be dropped in the gravity direction and washed by friction with the wash water. Recently, the drum type washing machine does not only wash the laundry but also dries the laundry by the hot air.

The washing machines with the drying function are classified into a condensation type washing machine and an exhaust type washing machine. In the condensation type washing machine, the hot air generated by a heater is sent to a drum by a ventilation fan, for drying the laundry in the drum. After drying the laundry, the air in the drum becomes the high temperature high humidity air and flows to an exhaust hole communicating with a tub. A nozzle for spraying the cold water is installed at one side of the exhaust hole, for removing moisture from the high temperature high humidity air, and supplying the dry air to the ventilation fan again.

In the exhaust type washing machine, the hot air generated by a heater and a ventilation fan is passed through the laundry in a drum, and externally exhausted from the washing machine through an exhaust hole formed at one side of the washing machine. The exhaust hole is linked to a corrugated hose connected to a tub. In case a baby or a pet is kept shut up in the washing machine, the exhaust hole serves as a vent hole.

When the exhaust type washing machine with the drying function dries the laundry, lint (fine fluff) is generated from the laundry. The lint is circulated with the hot air in the drum of the washing machine, and externally discharged from the washing machine through the exhaust hole.

A structure for periodically collecting the lint generated from the laundry after washing is provided to prevent the lint from being accumulated on the exhaust hole of the washing machine. That is, a lint filter is mounted in the exhaust hole to prevent the lint from clogging up the exhaust hole in long time use of the washing machine.

In the conventional dryer, the exhaust hole passes through an outer wall. The initial state of the exhaust hole (in installation) passing through the outer wall is not checked. Therefore, an installer must arbitrarily judge whether the exhaust hole satisfies the minimum specification for the operation of the dryer.

The conventional dryer recommends filter cleaning in every use. However, the user does not carefully clean the filter due to inconvenience and complication of filter cleaning. The filter is gradually clogged by repeated drying, which increases the drying time or power consumption. When the filter is seriously clogged up, fine lint is not collected in the filter but floats and sticks to the laundry and the dryer and contaminates the laundry. Moreover, in the case of the exhaust type dryer, if the lint clogs the exhaust hole for externally exhausting the used air and interrupts flow of the air, the user cannot easily check clogging of the exhaust hole.

In addition, the conventional dryer judges or checks clogging of the exhaust hole, but does not provide an additional safety device for the user in clogging of the exhaust hole.

### DISCLOSURE OF THE INVENTION

The present invention is achieved to solve the above problems. An object of the present invention is to provide a dryer with safety function which can display a clogging state of an air passage and interrupt an operation of the dryer according to the clogging state of the air passage.

Another object of the present invention is to provide a control panel for a dryer which can interrupt an operation of the dryer in clogging of an exhaust duct, release the interrupted operation, and display the state.

Yet another object of the present invention is to provide a dryer with safety function which can continuously display an operation interruption state of the dryer, and resume the operation of the dryer according to a release input from the user.

In order to achieve the above-described objects of the invention, there is provided a dryer with safety function, including: a judgment means for judging clogging of an exhaust duct; and a display means interworking with the judgment means, for displaying the clogging state of the exhaust duct when the exhaust duct of the dryer is clogged. The user can be rapidly informed of the clogging state of the exhaust duct.

The dryer includes a driving interruption means for interrupting driving of the dryer when the exhaust duct of the dryer is clogged. Therefore, the dryer interrupts driving of the dryer for safety of the user individually from or cooperatively with the recognition of the user about the clogging state of the exhaust duct.

The dryer includes an input means for acquiring a function setting command for activating the driving interruption means when the exhaust duct of the dryer is clogged from the user. Thus, the user can set and release the driving interruption function.

The driving interruption means interrupts a drying operation of the dryer. Accordingly, the drying operation associated with the safety is interrupted, and a display function and driving of a microcomputer which are not associated with the safety are continuously carried out.

The display means interworks with the driving interruption means, for displaying the driving interruption state of the dryer, so that the user can directly recognize driving interruption by the clogging state of the exhaust duct without misunderstanding it as an error of the dryer.

The dryer includes a release input means for acquiring a release input for releasing the driving interruption state of the dryer by the driving interruption means from the user. When the user intends to resume the drying operation of the dryer after appropriately handling the exhaust duct, or when the user recognizes the clogging state of the exhaust duct, the user can perform the drying operation of the dryer. The release input means helps the user to precisely recognize the clogging state of the exhaust duct.

The release input means is formed on a control panel of the dryer, so that the user can easily release the driving interruption.

The display means interworks with the release input means, for displaying the release state of the driving interruption of the dryer. When the driving interruption is released, the user can recognize that the dryer can be driven.

The dryer includes a storing means for storing a driving state of the dryer. After power supply of the dryer is cut off, when the user intends to use the dryer by supplying power, the user can be informed of the driving state of the dryer.

The driving state includes a driving interruption state by the operation of the driving interruption means or a driving possible state by the release input. Thus, the user can precisely recognize the driving related state of the dryer.

In another aspect of the present invention, there is provided a control panel for a dryer, including: a display means for displaying driving interruption of the dryer by clogging of an exhaust duct; and a release input means for acquiring a release input for releasing the driving interruption from the user. Therefore, the control panel for the dryer displays the driving interruption state, and enables the user to input the release input for releasing the driving interruption state.

The control panel for the dryer includes a setting input means for acquiring a function setting command for interrupting driving of the dryer in clogging of the exhaust duct from the user. The user can selectively set the driving interruption function.

The display means visibly or audibly displays the driving interruption state, so that the user can directly or rapidly recognize the driving interruption state or the clogging state of the exhaust duct.

The input means applies the input of the user to a control unit of the dryer after the display means displays the driving interruption. After the user checks the clogging state, driving of the dryer is resumed.

In yet another aspect of the present invention, there is provided a dryer with safety function, including: a storing means for storing a driving state of the dryer; a driving interruption means for interrupting driving of the dryer according to the driving state of the dryer; an input means for acquiring a release input for releasing driving interruption from the user in the driving interruption state of the dryer; and a release means for releasing the driving interruption by the driving interruption means according to the release input from the input means. The dryer independently interrupts the driving function of the dryer and confirms release of the interruption from the user. As a result, the user can safely use and drive the dryer.

The dryer displays the driving interruption state or the release state of the driving interruption, so that the user can check the current state of the dryer.

The driving interruption means interrupts a drying operation of the dryer. The other functions of the dryer except the drying operation can be continuously carried out.

### BRIEF DESCRIPTION OF THE DRAWINGS

The present invention will become better understood with reference to the accompanying drawings which are given only by way of illustration and thus are not limitative of the present invention, wherein:

FIG. 1 is a cross-sectional view illustrating a dryer in accordance with the present invention;

FIG. 2 is an exploded perspective view illustrating the dryer in accordance with the present invention;

FIG. 3 is a partial cutaway view illustrating the dryer in accordance with the present invention;

FIG. 4 is a configuration view illustrating a dryer with safety function in accordance with the present invention;

FIG. 5 is a graph showing on/off recognized by a microcomputer;

FIG. 6 is a flowchart showing one example of driving of the dryer with safety function in accordance with the present invention; and

FIG. 7 is a flowchart showing another example of driving of the dryer with safety function in accordance with the present invention.

### BEST MODE FOR CARRYING OUT THE INVENTION

A dryer with safety function in accordance with the preferred embodiments of the present invention will now be described in detail with reference to the accompanying drawings.

Various claimable aspects of the present invention will now be described. The following description becomes part of the detailed description of the present invention. The following description must be recognized as the technical ideas of the present invention understood in various viewpoints, or the minimum technology for the safety device for the dryer according to the present invention, not as a limiting boundary of the present invention.

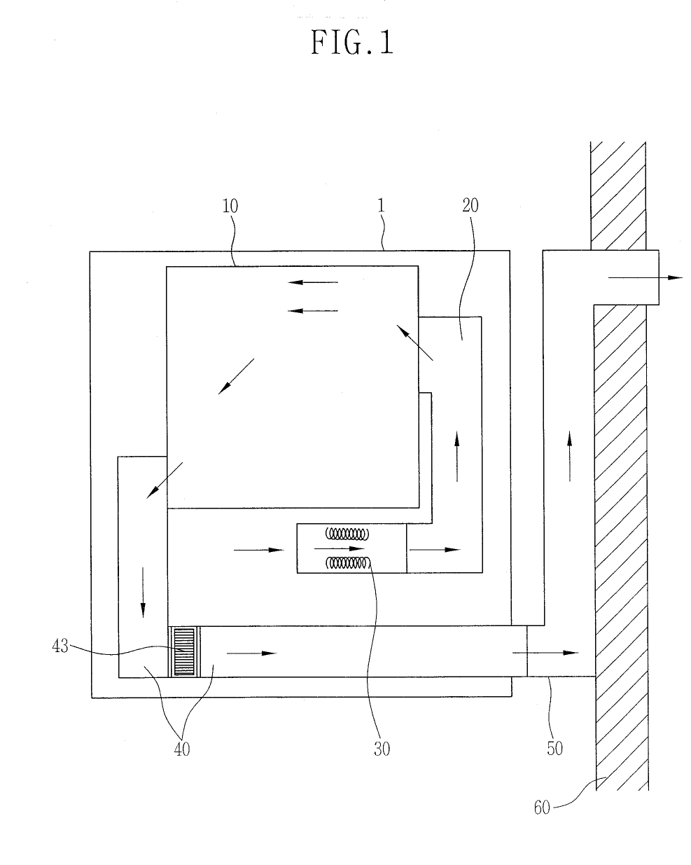

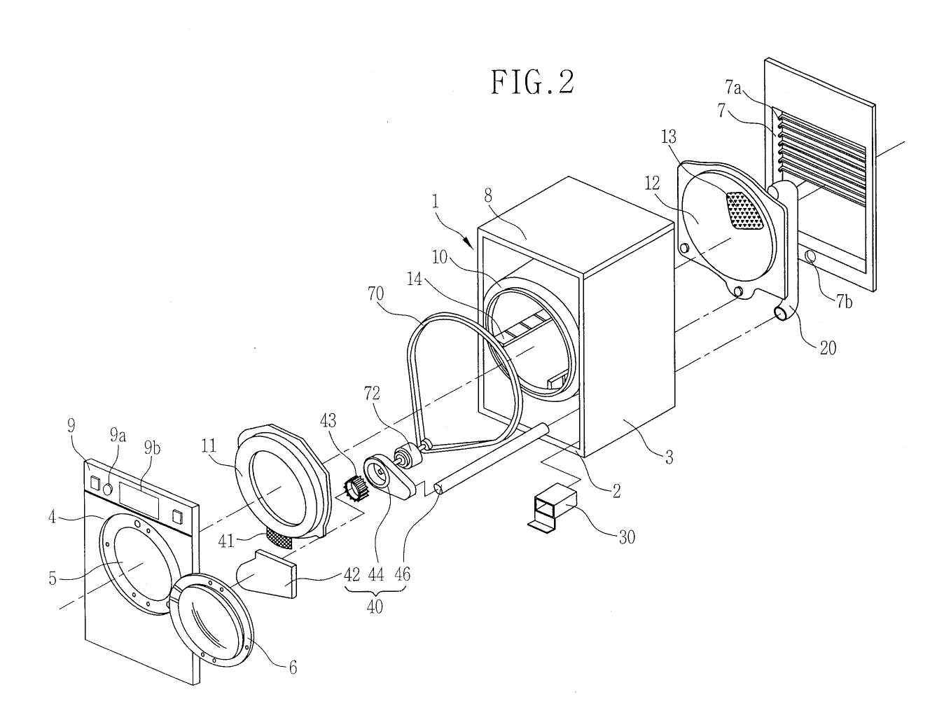

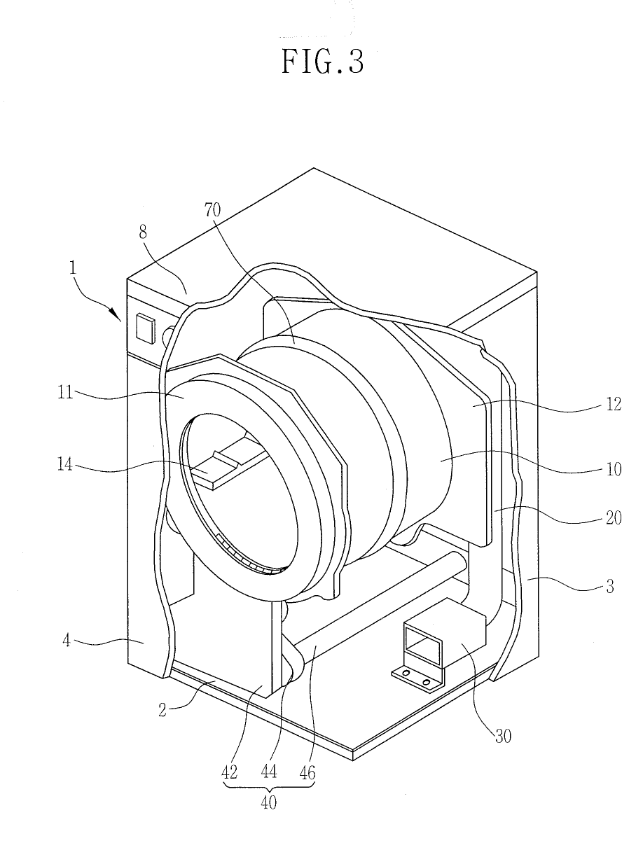

FIG. 1 is a cross-sectional view illustrating a dryer in accordance with the present invention, FIG. 2 is an exploded perspective view illustrating the dryer in accordance with the present invention, and FIG. 3 is a partial cutaway view illustrating the dryer in accordance with the present invention. An exhaust type dryer is exemplified below, which is not intended to be limiting.

Referring to FIG. 1, the exhaust type dryer 1 includes a drum 10 disposed in a cabinet 1, for containing the laundry, a suction passage 20 for supplying the air into the drum 10, a heater 30 installed on the suction passage 20, and an exhaust passage 40 for externally exhausting the air passing through the drum 10 from the cabinet 1. In the case of the exhaust type dryer 1, an exhaust duct 50 is coupled to the exhaust passage 40, for externally exhausting the air through an inner wall 60 of a building.

A ventilation fan 43 is installed at one side of the suction passage 20 or the exhaust passage 40. Hereinafter, it is presumed that the ventilation fan 43 is installed at one side of the exhaust passage 40.

As illustrated in FIGS. 2 and 3, the cabinet 1 includes a base pan 2, a cabinet main body 3 installed at the upper portion of the base pan 2, a cabinet cover 4 installed on the front surface of the cabinet main body 3, a back panel 7 installed on the rear surface of the cabinet main body 3, a top cover 8 installed on the top surface of the cabinet main body 3, and a control panel 9 installed at the top end of the cabinet cover 4.

Still referring to FIG. 2, a laundry inlet 5 for putting the laundry into the drum 10 is formed on the cabinet cover 4, and a door 6 for opening and closing the laundry inlet 5 is rotatably connected to the cabinet cover 4. The control panel 9 is installed at the top end of the cabinet cover 4. The control panel 9 includes an input unit 9a for acquiring an input from the user, and a display unit 9b for displaying the state of the dryer 1 (for example, the drying processing state, the drying processing degree, the remaining drying time, selection of the drying mode, etc.). A front supporter 11 for rotatably supporting the front end of the drum 10 is mounted at the rear portion of the cabinet cover 4.

A rear supporter 12 for rotatably supporting the rear end of the drum 10 is mounted at the front portion of the back panel 7. A communication hole 13 for making the suction passage 20 and the inlet portion of the drum 10 communicate with each other is formed on the rear supporter 12, so that the air passing through the suction passage 20 can be supplied to the inlet portion of the drum 10.

As shown in FIGS. 2 and 3, the drum 10, which is a cylindrical container for containing the laundry, is opened in the forward and backward directions, so that the air can pass through the drum 10 in the forward and backward directions. The rear opening portion forms the inlet portion of the drum 10, and the front opening portion forms the outlet portion of the drum 10. A lift 14 for lifting and dropping the laundry in rotation of the drum 10 is protruded from the inner circumference of the drum 10.

The suction passage 20 is formed by a suction duct having its bottom end connected to communicate with the rear end of the heater 30 and its top end connected to communicate with the communication hole 13 of the rear supporter 12.

Still referring to FIGS. 2 and 3, the heater 30 installed on the top surface of the base pan 2 includes a heater casing communicating with the suction passage 20, namely, the suction duct 20, and a heat generation coil arranged in the heater casing. When power is supplied to the heat generation coil, the inside space of the heater casing and the heater casing itself are heated so that the air passing through the heater casing can be converted into the high temperature low humidity air.

The exhaust passage 40 is formed by a lint duct 42 communicating with the outlet portion of the drum 10 to exhaust the air from the drum 10, a lint filter 41 for filtering off impurities such as lint from the exhausted air being mounted on the lint duct 42, a fan housing 44 communicating with the lint duct 42 and housing a ventilation fan 43, and an exhaust pipe 46 having its one end connected to communicate with the fan housing 44, and its other end externally elongated from the cabinet 1. The exhaust duct 50 for guiding the air externally exhausted from the cabinet 1 to the outdoor space is connected to the exhaust pipe 46. The exhaust duct 50 is formed outside the cabinet 1, for guiding the air to the outdoor space. The exhaust duct 50 can be installed to pass through the inner wall 60 of the building.

In accordance with the present invention, the air passage includes the suction passage 20, the inside space of the drum 10, the exhaust passage 40 and the exhaust duct 50. Clogging of the air passage mostly occurs in the lint filter 41 of the exhaust passage 40 and the exhaust duct 50. The air flow is relatively less interrupted by clogging of the lint filter 41 of the exhaust passage 40 than clogging of the exhaust duct 50.

The operation of the exhaust type dryer 1 in accordance with the present invention will now be described.

When the user puts the laundry into the drum 10, closes the door 6 and operates the exhaust type dryer 1 by controlling the control panel 9, the exhaust type dryer 1 turns on the heater 30 and drives a motor 72.

When the heater 30 is turned on, the heater 30 heats the inside of the dryer 1, and when the motor 72 is driven, a belt 70 and the ventilation fan 43 are rotated. When the belt 70 is rotated, the drum 10 is rotated. The laundry in the drum 10 is repeatedly lifted and dropped by the lift 14.

When the ventilation fan 43 is rotated, the outdoor air of the cabinet 1 is sucked into an air suction hole 7a of the back cover 7 by an air blast force of the ventilation fan 43, and supplied to a gap between the cabinet 1 and the drum 10. The air in the gap between the cabinet 1 and the drum 10 is introduced to the heater 30, heated into the high temperature low humidity air, and sucked into the drum 10 through the suction passage 20 and the communication hole 13 of the rear supporter 12.

The high temperature low humidity air sucked into the drum 10 flows in the forward direction of the drum 10, becomes the high humidity air by contact with the laundry, and is exhausted to the exhaust passage 10.

The air exhausted to the exhaust passage 40 is passed through the exhaust pipe 46, and externally exhausted through the exhaust duct 50.

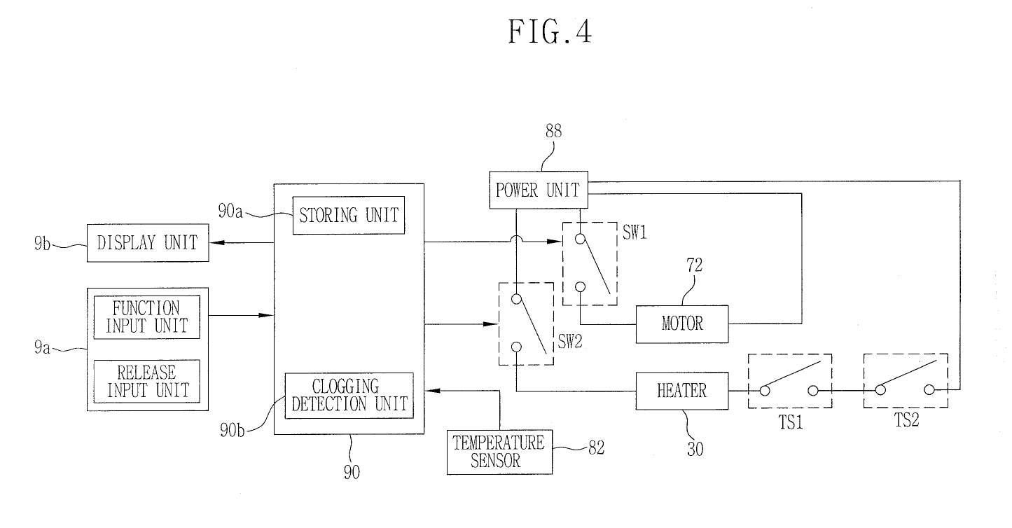

FIG. 4 is a configuration view illustrating a dryer with safety function in accordance with the present invention. As depicted in FIG. 4, the dryer includes the input unit 9a for acquiring a user input such as operation selection of the dryer 1, the display unit 9b for displaying an operation state of the dryer 1, the heater 30, the motor 72, a temperature sensor 82 for sensing a temperature of the exhaust passage 40, a power unit 88 for receiving external common power, and applying power to the heater 30, the motor 72, etc., first and second thermostats TS1 and TS2 for supplying power from the power unit 88 to the heater 30, the first and second thermostats TS1 and TS2 being turned on/off according to a temperature of the heater 30 or a temperature of the air heated by the heater 30, switches SW1 and SW2 turned on/off by a control command of a microcomputer 90, for applying power to the motor 72 and the heater 30, and the microcomputer 90 for interrupting the drying operation according to the clogging state or degree of the air passage from the detection circuit 80. The microcomputer 90 includes a storing unit 90a for storing a function selection command of the user for interrupting the operation of the dryer 1 according to the clogging state or degree of the air passage, reference information for judging the clogging state or degree of the air passage, and a current driving state of the dryer 1, and a clogging detection unit 90b for checking the clogging state or degree of the air passage. The power unit 88, which supplies DC power used in the microcomputer 90, the input unit 9a and the display unit 9b, can be easily understood by the ordinary people in the field to which the present invention pertains. Therefore, explanations thereof are omitted.

The first and second thermostats TS1 and TS2, which are a kind of temperature control units, are mounted in the side or proximity of the heater 30, and react to the temperature of the heater 30 or the temperature of the air heated by the heater 30. If the temperature does not reach a predetermined overheat temperature, the first and second thermostats TS1 and TS2 are continuously on. If the temperature exceeds the overheat temperature, the first and second thermostats TS1 and TS2 are turned off not to apply the common power to the heater 30. Especially, once the first thermostat TS1 is turned off, it does not return to the on state. For example, the first and second thermostats TS1 and TS2 are mounted on the suction passage 20 connected to the heater 30.

The switches SW1 and SW2 are a kind of relays. The switches SW1 and SW2 are continuously on during the drying operation by the on control of the microcomputer 90, thereby supplying power to the heater 30 and the motor 72, respectively. Meanwhile, when the switches SW1 and SW2 are turned off by the off control of the microcomputer 90, power supply to the heater 30 and the motor 72 is intercepted.

The input unit 9a receives a control command for drying from the user, and applies the control command to the microcomputer 90. Basically, the input unit 9a acquires the user input relating to the drying operation of the dryer 1. Especially, in accordance with the present invention, the input unit 9a includes a function input unit for acquiring a function selection/release command for interrupting the drying operation of the dryer 1 according to the clogging state or degree of the air passage from the user, and, when the microcomputer 90 interrupts the drying operation of the dryer 1 according to such function selection, a release input unit for acquiring a release command for releasing the interruption of the drying operation from the user. The function selection command and the function release command of the user using the function input unit of the input unit 9a are transmitted to the microcomputer 90 and stored in the storing unit 90a. The release command for releasing the driving interruption inputted by the user through the release input unit of the input unit 9a is transmitted to the microcomputer 90 and stored in the storing unit 90a. The input unit 9a is formed on the front surface of the control panel 9. Especially, the release input unit can be installed on the rear surface of the cabinet main body 3.

The display unit 9b displays the user input for the drying operation, the drying processing degree, the remaining drying time, the current clogging state or degree of the air passage, setting of the function selection command or the function release command by the user, and the driving interruption state or driving possible state of the dryer. The display unit 9b can visibly and audibly display the above items (for example, by a built-in speaker). In the case of the visible display, the display unit 9b uses characters, numbers, texts, icons, avatar characters, etc.

The temperature sensor 82 is mounted near the exhaust passage 40, for sensing a temperature of the exhaust passage 40 or a temperature of the air passing through the exhaust passage 40. Especially, the temperature sensor 82 is mounted to sense the temperature of the air passing through the lint filter 41.

As described above, the microcomputer 90 performs the drying operation by controlling the heater 30, the switches SW1 and SW2 and the motor 72 according to the command of the user from the input unit 9a, and operating the ventilation fan 43 by the motor 72.

The microcomputer 90 is mounted on the rear surface of the control panel 9. The microcomputer 90 enables the clogging detection unit 90b to judge the clogging state or degree of the air passage according to the function selection command or the function release command stored in the storing unit 90a, and interrupts driving of the drying operation of the dryer 1 according to the clogging state or degree of the air passage. For example, an EEPROM is used as the storing unit 90a. The clogging detection unit 90b can be provided as a separate circuit from the microcomputer 90, or a part of the microcomputer 90 as shown in FIG. 4. In accordance with the present invention, the clogging detection unit 90b judges the clogging state or degree of the air passage by using, as basic factors, the on/off commands applied from the microcomputer 90 to the switch SW2 according to the temperature sensed by the temperature sensor 82. The judgment procedure will later be explained.

So as to interrupt driving of the drying operation of the dryer 1 according to the clogging state or degree of the air passage, the microcomputer 90 applies the off commands to the switches SW1 and SW2 to turn off the motor 72 and the heater 30, thereby interrupting driving of the dryer 1.

In the driving interruption state, until the microcomputer 90 acquires the driving release command from the user through the release input unit of the input unit 9a, the microcomputer 90 ignores any command for the drying operation from the user. That is, the microcomputer 90 does not perform the drying operation of the dryer 1 until it acquires the driving release command from the user. However, the microcomputer 90 performs the operations which are not associated with the drying operation of the dryer 1, such as input of the driving release command or variation of the other setting, according to the user input.

The process of judging the clogging state or degree of the air passage by the microcomputer 90 will now be described.

In order to maintain the temperature of the exhaust passage 40 within a predetermined range (for example, 100 to 110° C.), the microcomputer 90 controls heat generation of the heater 30 by turning on/off the switch SW2 according to the temperature sensed by the temperature sensor 82.

The microcomputer 90 (or the clogging detection unit 90b) uses the following state. For example, if the air passage (especially, the exhaust duct 50 or the lint filter 41) is seriously clogged up, since the air flow from the outdoor space is not smooth, the temperature of the heater 30 or the temperature of the air heated by the heater 30 is raised to influence the first and second thermostats TS1 and TS2 (hereinafter, referred to as ‘temperature control unit’). However, the temperature sensed by the temperature sensor 82 is relatively slowly raised because the air flow is not smooth. The microcomputer 90 checks the state of the air passage by using the fact that the on/off control for the switch SW2 is changed according to the state of the air passage. Here, the state of the air passage includes the clogging degree and the clogged part location of the air passage. For example, if the lint filter 41 is more or less clogged, the clogging degree is weak, and if the exhaust duct 50 is clogged, the clogging degree is serious.

When the clogging degree of the air passage is weak, the air temperature influencing the temperature control unit is rarely different from the temperature sensed by the temperature sensor 82. Even if the temperature is continuously raised, before the temperature control unit intercepts power, the microcomputer 90 controls off of the switch SW2.

Conversely, when the clogging degree of the air passage is serious, the air temperature influencing the temperature control unit is much higher than the temperature sensed by the temperature sensor 82. Before the microcomputer 90 controls the switch SW2, the temperature control unit is automatically turned off. Accordingly, the microcomputer 90 controls the switch SW2 after a long time only when the air temperature of the exhaust passage 40 exceeds a predetermined range. However, when the microcomputer 90 checks the state of the air passage after the first use of the dryer 1 or cleaning of the lint filter 41, the microcomputer 90 checks the state (clogging) of the exhaust duct 50.

The exhaust passage 40 and the exhaust duct 50 communicate with each other. Therefore, when controlling the heater 30 by using the temperature sensor 82 mounted in the exhaust passage 40, the microcomputer 90 can check the clogging degree of the lint filter 41 of the exhaust passage 40 and the clogging degree of the exhaust duct 50 by the control operation using the temperature sensing of the exhaust passage 40.

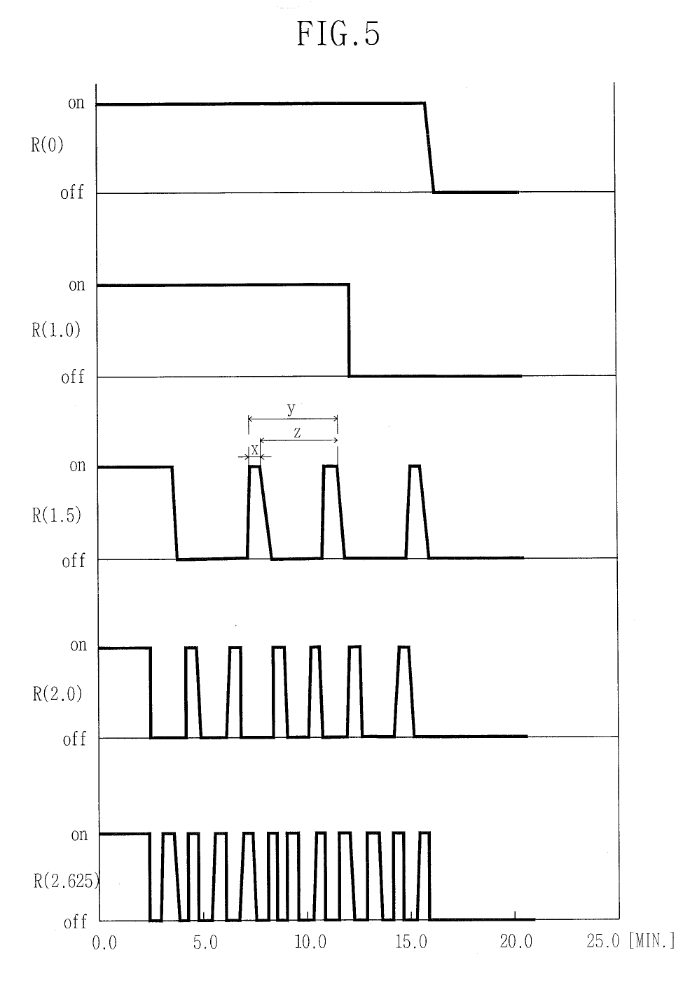

FIG. 5 is a graph showing on/off of the drying operation by temperature recognized by the microcomputer of FIG. 4. In FIG. 5, R represents a diameter of the exhaust duct 50, and the used unit is inch. In the case that the diameter of the exhaust duct 50 is R(0), R(1.0), R(1.5), R(2.0) and R(2.625), the microcomputer 90 turns on/off the switch SW2 according to the temperature sensed by the temperature sensor 82. If the diameter is large, the state (clogging degree) of the air passage is weak, and if the diameter is small, the state (clogging degree) of the air passage is serious.

A method for computing an on/off duty ratio of power supply is suggested to check the state of the air passage. In this embodiment, one or both of the on duty ratio (x/y) and the off duty ratio (z/y) can be used. Table 1 shows the states of the air passage according to the experiment results including the graph of FIG. 5.

TABLE 1

| Off duty ratio | Clogging degree | Clogged part |
|---|---|---|
| 0~0.30 | — | — |
| 0.30~0.45 | Low (weak) | Lint filter |
| 0.45~0.60 | Middle | Lint filter |
| 0.60~ | High (serious) | Exhaust duct |

The storing unit 90a stores the lookup table such as Table 1, the microcomputer 90 performs the drying operation, and the clogging detection unit 90b computes the off duty ratio (or the on duty ratio) reflecting the characteristic of the on/off commands applied to the switch SW2, compares the lookup table with the prestored lookup table, and checks the clogging state (clogging degree and clogged part) of the corresponding region. The clogging detection unit 90b applies the clogging state or degree of the air passage to the microcomputer 90, so that the microcomputer 90 can perform an appropriate operation (for example, continuance of the drying operation, driving interruption of the drying operation, etc.).

In addition, the storing unit 90a stores the currently checked state of the air passage, and the microcomputer 90 displays the state of the air passage through the display unit 9b. In installation of the dryer 1, the microcomputer 90 notifies successful installation to the user (or installer). That is, if the clogging degree of the air passage is serious (namely, if the exhaust duct 50 is clogged up), the microcomputer 90 can interrupt driving of the drying operation of the dryer 1 according to the function selection command stored in the storing unit 90a.

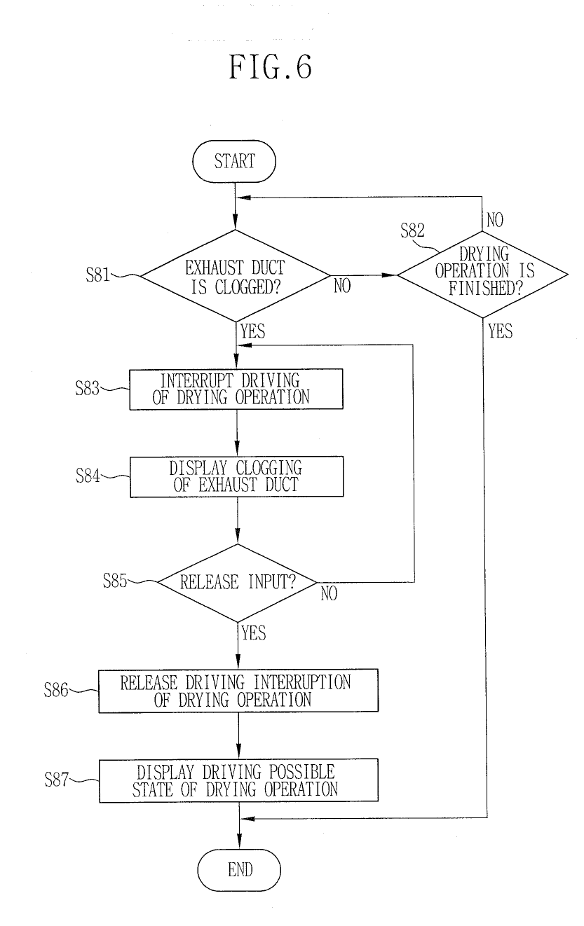

FIG. 6 is a flowchart showing one example of driving of the dryer with safety function in accordance with the present invention. The driving flowchart of FIG. 6 shows a state where the user selects the function of interrupting driving of the dryer 1 according to the clogging state or degree of the air passage. Here, the microcomputer 90 is performing the drying operation, or has already finished the drying operation.

In detail, in step S81, when the microcomputer 90 is performing the drying operation, the clogging detection unit 90b recognizes the information on the on/off command to the switch SW2 in a real time, or when the microcomputer 90 has finished the drying operation, the clogging detection unit 90b recognizes the information on all on/off commands to the switch SW2. The clogging detection unit 90b judges the clogging state or degree of the air passage, and applies the judgment result to the microcomputer 9Q. As the judgment result of the clogging detection unit 90b, if the exhaust duct 50 is clogged up, the microcomputer 90 goes to step S83, and if not, the microcomputer 90 goes to step S82.

In step S82, the microcomputer 90 judges whether the drying operation has been finished. If the drying operation has been finished, the microcomputer 90 ends the routine, and if the drying operation is being performed, the microcomputer 90 goes to step S81 and continuously checks the clogging state or degree of the air passage.

In step S83, the microcomputer 90 applies the off control command to the switch SW2 to turn off the heater 30, and then applies the off control command to the switch SW1 to turn off the motor 72. A fire of the dryer 1 or the exhaust duct 50 can be preferentially prevented by interrupting heat generation of the heater 30 by the sequential control. Thereafter, the microcomputer 90 stops the motor 72 exhausting the air from the air passage, thereby interrupting the drying operation of the dryer 1.

In step S84, the microcomputer 90 displays the clogging state and degree of the exhaust duct 50, and also displays interruption of the drying operation of the dryer 1. Therefore, the user can check the clogging degree of the exhaust duct 50, and perform an appropriate operation (for example, cleaning of the exhaust duct 50, repair, etc.). The microcomputer 90 stores the checked clogging state and degree of the exhaust duct 50 in the storing unit 90a, and also stores the driving interruption state of the dryer 1.

In step S85, the microcomputer 90 judges whether the release command for releasing the driving interruption state has been acquired from the user through the release input unit of the input unit 9a. If the release command has been acquired, the microcomputer 90 goes to step S86, and if not, the microcomputer 90 goes to step S83 and maintains the driving interruption state.

In step S86, the microcomputer 90 converts the driving interruption state into the driving possible state according to the acquired release command, stores the driving possible state, and resumes the interrupted drying operation or performs the drying operation according to a succeeding command from the user.

In step S87, the microcomputer 90 displays the driving possible state of the drying operation of the dryer 1 stored in the storing unit 90a on the display unit 9b.

In the above step S85, the microcomputer 90 goes to step S83 in regard to the user input relating to start of the drying operation, thereby preventing the drying operation.

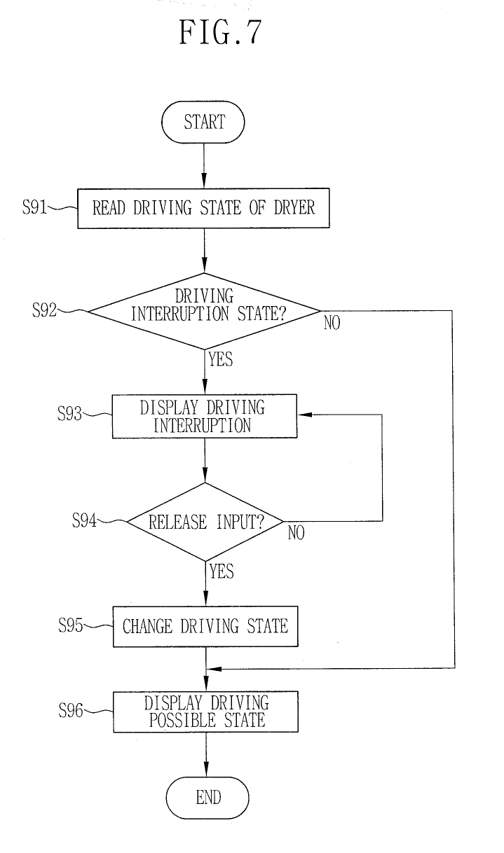

FIG. 7 is a flowchart showing another example of driving of the dryer with safety function in accordance with the present invention.

In detail, in step S91, when power is supplied to the dryer 1, the microcomputer 90 reads the driving state of the dryer 1 stored in the storing unit 90a.

In step S92, when the driving state of the dryer 1 is the driving interruption state, the microcomputer 90 goes to step S93, and if not, the microcomputer 90 goes to step S96.

In step S93, the microcomputer 90 displays the driving interruption state which is the read driving state on the display unit 9b, thereby informing the user of the driving interruption of the drying operation by clogging of the exhaust duct 50.

In step S94, the microcomputer 90 judges whether the release command for releasing the driving interruption state has been inputted through the release input unit of the input unit 9a. If the release command has been inputted, the microcomputer 90 goes to step S95, and if not, the microcomputer 90 goes to step S93. In the above step S93, the microcomputer 90 ignores the control input of the user associated with the drying operation of the dryer 1, thereby preventing the drying operation.

In step S95, the microcomputer 90 converts the driving state of the dryer 1 stored in the storing unit 90a. That is, the microcomputer 90 converts the driving interruption state of the dryer 1 into the driving possible state, and performs an operation according to the control input of the user associated with the drying operation.

In step S96, the microcomputer 90 displays the driving possible state which is the converted driving state on the display unit 9b, so that the user can be informed that he/she can input the drying control command and perform the drying operation of the dryer 1.

In the driving flowchart of FIG. 7, when power is intercepted in clogging of the exhaust duct 50 and then supplied to the dryer 1 again, the user can check the driving interruption state of the drying operation.

As discussed earlier, in accordance with the present invention, the dryer with safety function can prevent a fire of the dryer or the exhaust duct by displaying the clogging state of the air passage, and interrupting the operation of the dryer according to the clogging state of the air passage.

In addition, the control panel for the dryer can interrupt the operation of the dryer in clogging of the exhaust duct, release the interrupted operation, and display the state. Therefore, the user can be provided with the state of the exhaust duct and information on the cleaning and repair.

Furthermore, the dryer with safety function can continuously display the operation interruption state of the dryer, and resume the operation of the dryer according to the release input from the user, so that the user can continuously manage the exhaust duct.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A dryer with safety function, comprising:
a judgment means for judging clogging of an exhaust duct; and
a display means interworking with the judgment means, for displaying the clogging state of the exhaust duct when the exhaust duct of the dryer is clogged.

2. The dryer of claim 1, comprising a driving interruption means for interrupting driving of the dryer when the exhaust duct is clogged.

3. The dryer of claim 2, comprising an input means for acquiring a function setting command for activating the driving interruption when the exhaust duct is clogged from the user.

4. The dryer of claim 2, wherein the driving interruption means interrupts a drying operation of the dryer.

5. The dryer of claim 2, wherein the display means interworks with the driving interruption means, for displaying the driving interruption state of the dryer.

6. The dryer of claim 2, comprising a release input means for acquiring a release input for releasing the driving interruption state of the dryer by the driving interruption means from the user.

7. The dryer of claim 6, wherein the release input means is formed on a control panel of the dryer.

8. The dryer of claim 6, wherein the display means interworks with the release input means, for displaying the release state of the driving interruption of the dryer.

9. The dryer of claim 6, comprising a storing means for storing a driving state of the dryer, wherein the driving state comprises a driving interruption state by the operation of the driving interruption means or a driving possible state by the release input.

10. A control panel for a dryer, comprising:
a display means for displaying driving interruption of the dryer by clogging of an exhaust duct; and
a release input means for acquiring a release input for releasing the driving interruption from the user.

11. The control panel of claim 10, comprising a setting input means for acquiring a function setting command for interrupting driving of the dryer in clogging of the exhaust duct from the user.

12. The control panel of claim 10, wherein the display means visibly or audibly displays the driving interruption state.

13. The control panel of claim 10, wherein the input means applies the input of the user to a control unit of the dryer after the display means displays the driving interruption.

14. A dryer with safety function, comprising:
a storing means for storing a driving state of the dryer;
a driving interruption means for interrupting driving of the dryer according to the stored driving state;
an input means for acquiring a release input for releasing driving interruption from the user in the driving interruption state of the dryer; and
a release means for releasing the driving interruption by the driving interruption means according to the release input from the input means.

15. The dryer of claim 14, which displays the driving interruption state or the release state of the driving interruption.

16. The dryer of claim 14, wherein the driving interruption means interrupts a drying operation of the dryer.
